(19) United States
(12) Patent Application Publication
(10) Pub. No.: US 2010/0030831 A1
(43) Pub. Date: Feb. 4, 2010

(54) MULTI-FPGA TREE-BASED FFT PROCESSOR

(75) Inventor: Matthew Ryan Standfield, Dallas, TX (US)

Correspondence Address: HOVEY WILLIAMS LLP, 10801 Mastin Blvd., Suite 1000, Overland Park, KS, 66210, US

(73) Assignee: L-3 COMMUNICATIONS INTEGRATED SYSTEMS, L.P., Greenville, TX (US)

(21) Appl. No.: 12/185,223

(22) Filed: Aug. 4, 2008

(51) Int. Cl. G06F 17/14

(52) U.S. Cl. 708/404

(57) ABSTRACT

A fast Fourier transform (FFT) computation system comprises a plurality of field programmable gate arrays (FPGAs), a plurality of initial calculations modules, a plurality of butterfly modules, a plurality of external interfaces, and a plurality of FPGA interfaces. The FPGAs may include a plurality of configurable logic elements that may be configured to perform mathematical calculations for the FFT. The initial calculations modules may be formed from the configurable logic elements and may be implemented according to a split-radix tree architecture that includes a plurality of interconnected nodes. The initial calculations modules may perform the initial split-radix calculations of the FFT. The butterfly modules may be formed from the configurable logic elements and may be implemented according to the split-radix tree architecture to perform at least a portion of the FFT computation in an order that corresponds to the connection of the nodes of the split-radix tree architecture. The FPGA interfaces are included in each FPGA and allow communication between the FPGAs. The external interfaces are also included in each FPGA and allow communication with one or more external devices in order to receive data which requires an FFT computation and to transmit the FFT computation results.

### BACKGROUND OF THE INVENTION

1. Field of the Invention

Embodiments of the present invention relate to a fast Fourier transform architecture. More particularly, embodiments of the present invention relate to a system for calculating a fast Fourier transform that utilizes a split-radix tree-based architecture.

2. Description of the Related Art

The calculation of the discrete Fourier transform (DFT) involves many repetitive calculations. Cooley and Tukey realized this fact and developed an algorithm to significantly reduce the number of calculations required to compute the DFT. This algorithm became known as the fast Fourier transform (FFT). Implementations of the FFT usually include one or more processing elements to compute the FFT in stages, wherein the processing elements are generally implemented with a fixed-radix architecture, such as radix-2 or radix-4. The FFT typically operates on N points of data, where N is a power of 2, e.g., 2, 4, 8, 16, etc. Often, the fixed-radix architecture requires that N/radix# processors complete their calculations for every stage, wherein the total number of processors may depend on the number of stages. Furthermore, an entire stage of calculations for the N points of data is usually required to be complete before the next stage of calculations can begin. This type of architecture might not lend itself to implementation among distributed calculation resources, where the calculations for data of size less than N might be more easily performed on discrete components.

### SUMMARY OF THE INVENTION

Embodiments of the present invention solve the above-mentioned problems and provide a distinct advance in the art of calculating the fast Fourier transform. More particularly, embodiments of the invention provide a method and system for calculating the fast Fourier transform that utilize a split-radix tree-based architecture that may be implemented on multiple field programmable gate arrays.

A fast Fourier transform (FFT) computation system constructed in accordance with various embodiments of the current invention may comprise a plurality of field programmable gate arrays (FPGAs), a plurality of initial calculations modules, a plurality of butterfly modules, a plurality of external interfaces, and a plurality of FPGA interfaces. The FPGAs may include a plurality of configurable logic elements that may be configured to perform mathematical calculations for the FFT. The initial calculations modules may be formed from the configurable logic elements and may be implemented according to a split-radix tree architecture that includes a plurality of interconnected nodes. The initial calculations modules may perform the initial split-radix calculations of the FFT. The butterfly modules may be formed from the configurable logic elements and may be implemented according to the split-radix tree architecture to perform at least a portion of the FFT computation in an order that corresponds to the connection of the nodes of the split-radix tree architecture. The FPGA interfaces are included in each FPGA and allow communication between the FPGAs. The external interfaces are also included in each FPGA and allow communication with one or more external devices in order to receive data which requires an FFT computation and to transmit the FFT computation results.

A method in accordance with various embodiments of the current invention may comprise creating a split-radix tree architecture to accommodate a number of points for an FFT computation. A number of interconnected nodes are created within the tree architecture, wherein each node represents a plurality of mathematical calculations that compute at least a portion of the FFT. The connection of the nodes determines the order of the calculations. The tree architecture includes a plurality of leaf nodes, a plurality of branch nodes, and a single root node. Resources are allocated to compute the FFT among a plurality of FPGAs. The FFT computation is performed according to the tree architecture wherein the calculations associated with the leaf nodes are performed before the calculations associated with the branch nodes which are performed before the calculations associated with the root node.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the embodiments and the accompanying drawing figures.

### BRIEF DESCRIPTION OF THE DRAWING FIGURES

Embodiments of the present invention is described in detail below with reference to the attached drawing figures, wherein:

FIG. 1 is a block diagram of a multiple field-programmable gate array (FPGA) fast Fourier Transform (FFT) calculation system constructed in accordance with various embodiments of the current invention;

FIG. 2A is a block diagram of an initial calculations module configured for two radix-2 calculations;

FIG. 2B is a block diagram of the initial calculations module configured for one radix-4 calculation;

FIG. 3 is a tree diagram utilized in the calculation of an FFT;

FIG. 4 is a tree diagram depicting an implementation among one or more FPGAs;

FIG. 5 is a diagram depicting an implementation of the butterfly modules to perform the calculations of a sample FFT; and

FIG. 6 is a flow diagram depicting at least some of the steps that are performed for a method of calculating an FFT.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

A discrete Fourier transform (DFT) converts a time-sampled time-domain data stream into a frequency-domain representation of the data stream. The DFT is utilized for applications such as spectral analysis, where it is desired to know the frequency components of a signal, such as an audio signal, a video signal, or a signal derived from naturally occurring phenomena. The DFT computation includes many repetitive calculations which may be more efficiently computed using an algorithm known as a fast Fourier transform (FFT). The FFT is generally performed on points of data, or data that is sampled from a signal at regular time intervals. The number of points, N, is usually a power of 2, e.g., 4, 8, 16, 32, etc. Thus, the FFT is performed on N points of time-domain data. The result of the computation is N points of frequency-domain data.

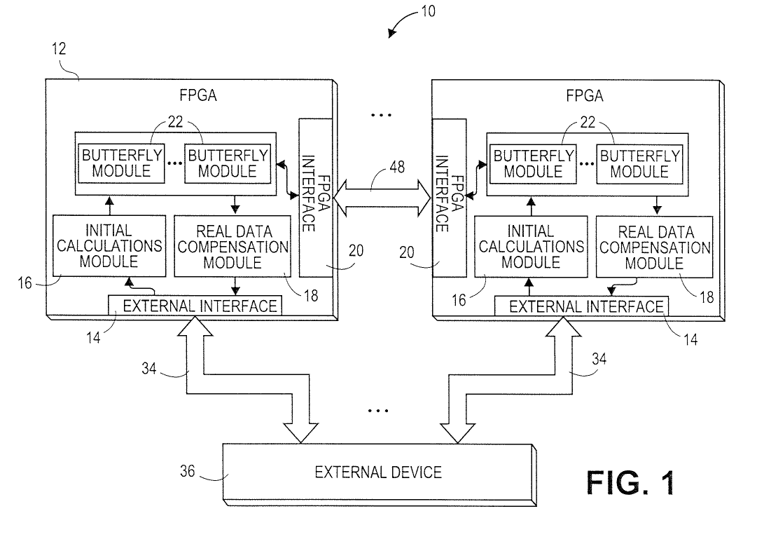

A multiple field-programmable gate array (FPGA) FFT computation system 10 as constructed in accordance with various embodiments of the current invention is shown in FIG. 1. The system 10 comprises a plurality of FPGAs 12, an external interface 14, an initial calculations module 16, a real-data compensation module 18, an FPGA interface 20, and a plurality of butterfly modules 22.

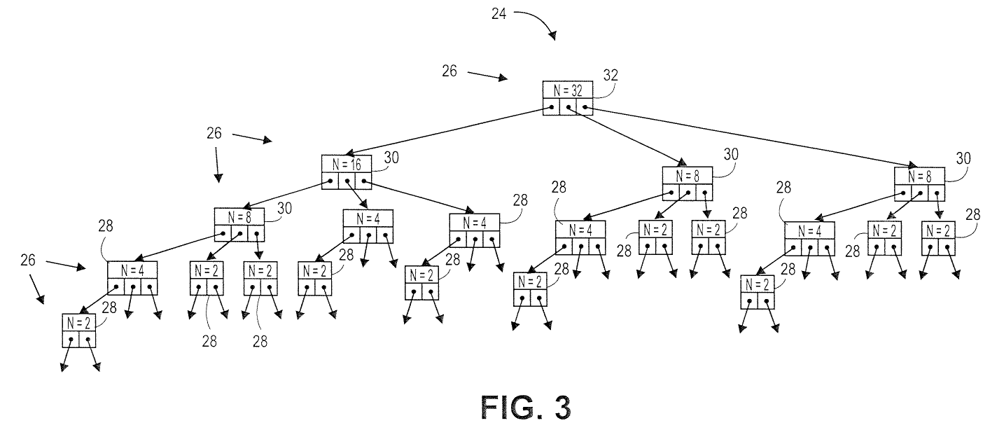

The system 10 performs the FFT computation according to the structure of a tree architecture 24. An example of the tree architecture 24 for a 32-point FFT is shown in FIG. 3, wherein each block in the drawing is an interconnected node 26 of the tree architecture 24, wherein there are leaf nodes 28, branch nodes 30, and a root node 32. Calculations are performed at each node 26 with the results being passed forward to the node 26 to which it is connected. Each node 26 as shown includes the number of points of data calculations that are performed at that node 26. The leaf nodes 28 perform a small number (N=2, N=4) of calculations. The branch nodes 30 perform a greater number of calculations. And the root node 32 performs the most calculations. Thus the root node 32 is the only node 26 where the calculations for all N points of data are performed.

The FPGA 12 generally provides the resources to implement the external interface 14, the initial calculations module 16, the real-data compensation module 18, the FPGA interface 20, and the butterfly modules 22. The FPGA 12 may include standard gate array components, such as configurable logic blocks that include combinational logic gates and latches or registers, programmable switch and interconnect networks, random-access memory (RAM) components, and input/output (I/O) pads. The FPGA 12 may also include specialized functional blocks such as arithmetic/logic units (ALUs) that include high-performance adders and multipliers, or communications blocks for standardized protocols. An example of the FPGA 12 is the Xilinx Virtex™ series, particularly the Virtex™-5 FPGA, from Xilinx, Inc. of San Jose, Calif.

The FPGA 12 may be programmed in a generally traditional manner using electronic programming hardware that couples to standard computing equipment, such as a workstation, a desktop computer, or a laptop computer. The functional description or behavior of the circuitry may be programmed by writing code using a hardware description language (HDL), such as very high-speed integrated circuit hardware description language (VHDL) or Verilog, which is then synthesized and/or compiled to program the FPGA 12. Alternatively, a schematic of the circuit may be drawn using a computer-aided drafting or design (CAD) program, which is then converted into FPGA 12 programmable code using electronic design automation (EDA) software tools, such as a schematic-capture program. The FPGA 12 may by physically programmed or configured using FPGA programming equipment, as is known in the art.

The external interface 14 generally provides communication with external components to manage the flow of data in and out of the system 10. The external interface 14 may prepare the incoming data for the FFT calculation by parsing the data and removing any header, packet, or framing information. The external interface 14 may also put the data in the proper numerical format to be operated on by the initial calculations module 16. Once the FFT calculation is complete, the external interface 14 may prepare the data to be received by other components or systems, such as by converting the numerical format of the data, or by adding headers, packet and framing information, or other communications, bus, or network protocol data. An example of the protocol that the external interface 14 may be compatible with is the PCI Express 2.0 or PCI Express 3.0.

The external interface 14 may be an endpoint component (compatible with the PCI Express or similar protocol) that is included as a built-in block of the FPGA 12 or may be programmed into the FPGA 12 using one or more code segments of a hardware description language (HDL) or other FPGA-programming language. Thus, each FPGA 12 might have its own external interface 14. In certain embodiments, the external interface 14 may be a standalone component that communicates with the FPGA 12 through the standard FPGA 12 I/O ports. Furthermore, there may be a plurality of external interfaces.

The external interface 14 may couple with a communications bus 34 that connects to one or more external devices 36, as shown in FIG. 1. The communications bus 34 may be a single-channel serial line, wherein all the data is transmitted in serial fashion, a multi-channel (or multi-bit) parallel link, wherein different bits of the data stream are transmitted on different channels, or a variation thereof, wherein the communications bus 34 may include multiple lanes of bi-directional data links. An example of the communications bus 34 is the PCI Express x8 or x16. The communications bus 34 may transmit and receive data electrically and may utilize various types of data encoding schemes, such as 8-bit/10-bit (8 b/10 b), or various implementation schemes, such as differential signaling. The communications bus 34 may also utilize various electrically-conductive elements, such as copper traces, on a printed circuit board (PCB) and may include PCB coupling components such as card-edge connectors or integrated circuit (IC) sockets.

While the communications bus 34 is described above as transmitting and receiving data electrically, the communications bus 34 may also communicate data optically or wirelessly. Thus, the communications bus 34 may include optical transmitting and receiving components, such as lasers, light-emitting diodes (LEDs), and detectors, as well as optical communications media, such as optical fibers or other waveguides. In addition, the communications bus 34 may include radio-frequency (RF) receivers and transmitters that are capable of communicating data according to standard protocols, such as the Institute of Electrical and Electronics Engineers (IEEE) wireless standards 802.11, 802.15, 802.16, and the like.

The external device 36, as shown in FIG. 1, may be an external component or may be a portion of another system that either sends data to the multiple FPGA FFT calculation system 10 or receives data from it. Alternatively, the external device 36 may be a switching element that is capable is coupling the communications busses 34 from a plurality of FPGAs 12 to a higher-bandwidth bus. For example, the external device 36 may be a PEX 8632 32-lane switch from PLX Technology, Inc. of Sunnyvale, Calif., which may connect the communications bus 34 like the PCI Express x8 bus from each of two FPGAs 12 to a high-bandwidth bus like the PCI Express x16.

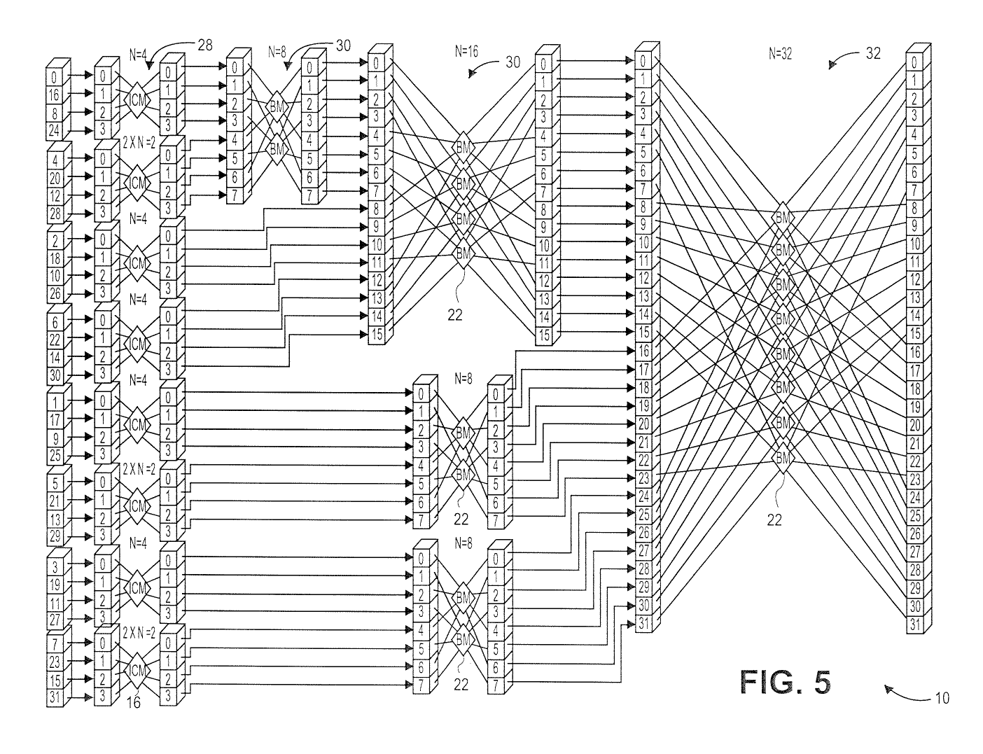

The initial calculations module 16 generally performs the initial calculations of the FFT according to the structure of the tree architecture 24. The initial calculations are those that are associated with the lowest nodes 26 of the tree architecture 24 as shown in FIG. 3. Each of these nodes 26 may also be considered a leaf node 28 of the tree architecture 24. This structure is also depicted in FIG. 5 (described in more detail below), which shows an implementation of a portion of the system 10 to calculate an exemplary 32-point FFT, according to the tree architecture 24 of FIG. 3. The initial calculations module 16 includes the modules that make the calculations on the left side of FIG. 5. These calculations must be performed before any of the calculations from other nodes 26 of the tree 024 can be made.

The system 10 generally performs calculations on a data set that is presented in bit-reverse order. An example of a data set presented in bit-reverse order is the column of numbers in boxes along the left side of the 32-point FFT implementation of FIG. 5. For an N-point FFT, the input time-sampled data set is usually presented in sampled order, numbered 0 through N-1. To produce bit-reversed order, the number of each sample is written or otherwise displayed in binary form. The bits of the sample number are then reversed, or displayed from right to left. For the 32-point FFT of FIG. 5, the samples are numbered from 0 to 31 (N-1). In binary, those numbers are represented by five bits, 00000 to 11111. The first sampled data point is numbered 00000. The bit-reverse representation is still 00000, or 0 in decimal. However, the second sampled data point is numbered 00001. Its bit-reverse representation is 10000, or decimal 16. The third sampled data point is number 00010. Its bit-reverse representation is 01000, or decimal 8. These numbers can be seen as the first three numbers in the left column of numbers in FIG. 5. The initial calculations module 16 may perform the bit-reverse function to present the data in the proper order to perform the FFT calculation.

When performing an FFT calculation on an N-point set of data with only real components, the initial calculations module 16 may interleave the odd-numbered and even-numbered samples, treating the odd-numbered samples as a real component and the even-numbered samples as an imaginary component, to create N/2 complex data samples. In the case of real-component only data, an N-point real FFT is treated as an N/2-point complex FFT that includes some additional calculations to compensate for the real-only data set, with the initial calculations module 16 putting the data in the proper order.

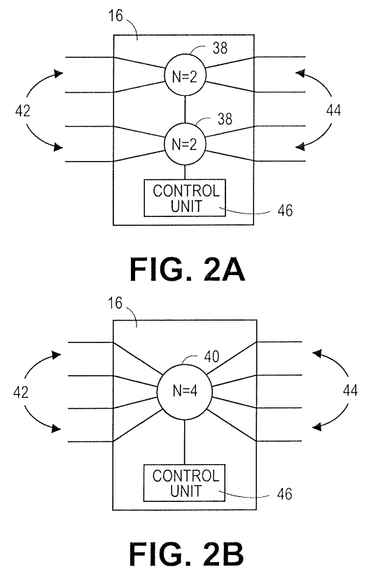

The initial calculations module 16 may include the components necessary to perform split-radix calculations, which include N=2 and N=4 calculations. Thus, the initial calculations module 16 may include one or more N=2 processors as well as one or more N=4 processors. An N=2 processor 38 may perform the calculations necessary for a 2-point FFT. An N=4 processor 40 may perform the calculations necessary for a 4-point FFT. In various embodiments, the initial calculations module 16 may include the necessary components that can be configured as either two N=2 processors 38, as shown in FIG. 2A or one N=4 processor 40, as shown in FIG. 2B. In these embodiments, there may be four inputs 42 to the initial calculations module 16 and four outputs 44. With two N=2 processors 38, two of the four inputs 42 may be connected to one N=2 processor 38 and the other two inputs 42 may be connected to the other N=2 processor 38. Likewise, the four outputs 44 may be split among the N=2 processors 38 as shown in FIG. 2A. When the initial calculations module 16 is configured as one N=4 processor 40, as depicted in FIG. 2B, all four inputs 42 and all four outputs 44 connect to the N=4 processor 40. A control unit 46, or the like, may be included in the initial calculations module 16 to coordinate the configuration between one N=4 processor 40 and two N=2 processors 38.

The initial calculations module 16 may include specialized functional blocks, combinational logic gates (e.g., AND, OR, NOT), adders, multipliers, multiply/accumulate units (MACs), ALUs, lookup tables, and the like. The initial calculations module 16 may also include buffers in the form of flip-flops, latches, registers, static RAM (SRAM), dynamic RAM (DRAM), and the like to store data before and after the calculations are performed, as well as the intermediate results while the initial calculations are being performed. The initial calculations module 16 may be formed from one or more code segments of an HDL or one or more schematic drawings, and may be programmed into the FPGA 12 as discussed above. The initial calculations module 16 is typically a component or group of components in the FPGA 12. However, in some embodiments, the initial calculations module 16 may be a component or group of components external to the FPGA 12.

The real-data compensation module 18 generally executes a final set of operations on the resulting data after an FFT has been performed on real-component only data. As described above, the odd and even numbered components of an N-point real-component only input data may be treated as real and imaginary components for an N/2-point complex-data FFT. Once the FFT has been calculated, the real-data compensation module 18 utilizes twiddle factors to perform a final calculation on the data to correct the reordering of the data in the time domain. In addition, whether the input data is real-only or is complex, the real-data compensation module 18 buffers the frequency-domain data before it is forwarded out of the system 10 through the external interface 14.

The real-data compensation module 18 may include combinational logic gates, ALUs, shift registers or other serial-deserializer (SERDES) components, and the like. The real-data compensation module 18 may also include buffers in the form of flip-flops, latches, registers, SRAM, DRAM, and the like.

The system 10 generally allows communication from one FPGA 12 to another FPGA 12. Typically, one or more butterfly modules 22 on one FPGA 12 sends data to one or more butterfly modules 22 on another FPGA 12. The FPGA interface 20 couples one or more butterfly modules 22 within the FPGA 12 to an inter-FPGA bus 48. The FPGA interface 20 may buffer the data and add packet data, serialize the data, or otherwise prepare the data for transmission on the inter-FPGA bus 48.

The FPGA interface 20 may include buffers in the form of flip-flops, latches, registers, SRAM, DRAM, and the like, as well as shift registers or SERDES components. The FPGA interface 20 may be a built-in functional FPGA block or may be formed from one or more code segments of an HDL or one or more schematic drawings, and may be programmed into the FPGA 12 as discussed above. The FPGA interface 20 may also be compatible with or include GTP components.

The inter-FPGA bus 48 generally carries data from one FPGA 12 to another FPGA 12 and is coupled with the FPGA interface 20 of each FPGA 12. The inter-FPGA bus 48 may be a single-channel serial line, wherein all the data is transmitted in serial fashion, a multi-channel (or multi-bit) parallel link, wherein different bits of the data stream are transmitted on different channels, or a variation thereof, wherein the communications bus 34 may include multiple lanes of bi-directional data links. The inter-FPGA bus 48 may be compatible with GTP components included in the FPGA interface 20. The inter-FPGA bus may also be implemented as disclosed in U.S. Patent Application No. 2005/0256969, filed May 11, 2004, which is hereby incorporated by reference in its entirety.

The inter-FPGA bus 48 may be implemented on a PCB and may utilize various electrically-conductive elements, such as copper traces. The inter-FPGA may also include optical media, such as optical backplanes or optical waveguides.

The butterfly module 22 generally computes at least a portion of the N-point FFT, wherein that portion may correspond to the calculations performed at one branch node 30 of the tree architecture 24. The butterfly modules 22 as a group receive the output of the initial calculations modules 16 and generally perform the calculations associated with the branch nodes 30 and the root node 32. The butterfly module 22 may operate alone or in parallel with other butterfly modules 22 to perform the calculations of a branch node 30, as seen in FIG. 5. The butterfly module 22 may generally include the components to perform a fixed-radix calculation, such as an N=4 calculation, substantially similar to the N=4 configured initial calculations module 16 as is shown in FIG. 2B. Furthermore, the butterfly module 22 may include buffers to store data before and after the calculations are performed, as well as the intermediate results while the calculations are being performed.

The butterfly module 22 may include specialized functional blocks, combinational logic gates (e.g., AND, OR, NOT), adders, multipliers, MACs, ALUs, lookup tables, and the like. The butterfly module 22 may also include buffers in the form of flip-flops, latches, registers, SRAM, DRAM, and the like. The butterfly module 22 may be formed from one or more code segments of an HDL or one or more schematic drawings, and may be programmed into the FPGA 12 as discussed above.

The tree architecture 24 generally determines the nature and the order of the calculations to compute the FFT, and includes a plurality of leaf nodes 28, a plurality of branch nodes 30, and a single root node 32, as seen in FIG. 3. The leaf nodes 28 are the lowest of the tree, the branch nodes 30 are in the middle of the tree, and the root node 32 is at the top of the tree, in FIG. 3. The leaf node 28 calculations are performed before the branch nodes 30 and the root node 32. The tree may be formed by applying a recursive split-radix algorithm that determines the relationship between the nodes 26 of the tree. The algorithm is summarized as follows. The value of N for an N-point FFT is treated as the root node 32. Three branch nodes 30 are created below the root node 32 where each node 26 represents a smaller FFT with the first node 26 representing N/2, the second node 26 representing N/4, and the third node 26 representing an FFT of N/4. A line may be drawn connecting the lower nodes 26 to the upper node 26. The value of each of the three new branch nodes 30 is reset to equal N. The node creation step is applied again, such that below each branch node 30 that was just created, three new nodes 26 are created with values of N/2, N/4, and N/4. This step is applied recursively until the values of the lower nodes 26 are N=2 or N=4. For N=2, no further action is needed. For N=4, only a single node 26 is created below it with a value of N=2. The N=4 and N=2 nodes 26 are the leaf nodes 28 of the tree and are also representative of the calculations that are performed by the initial calculations module 16. FIG. 3 shows an application of this algorithm to a 32-point FFT calculation.

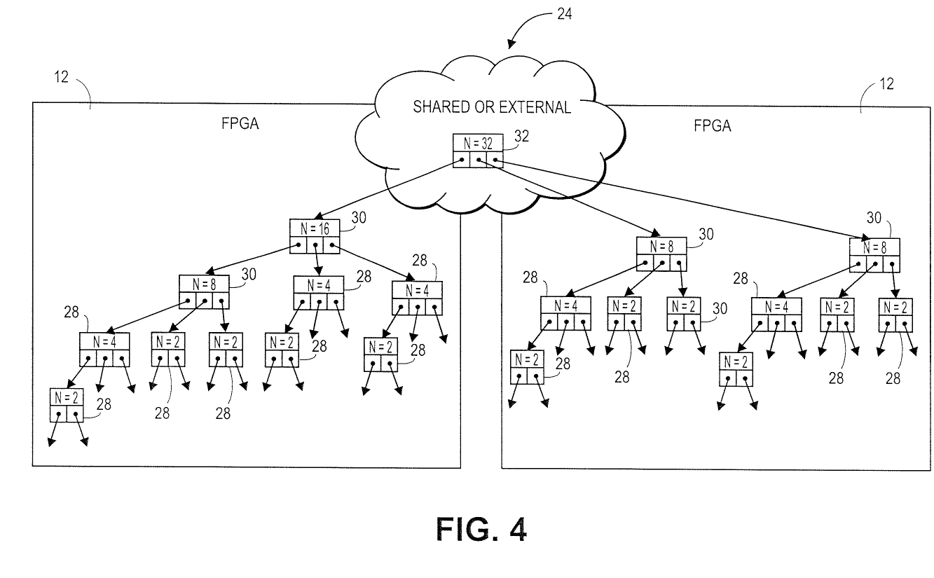

The tree architecture 24 may be distributed among a plurality of FPGAs 12. Some node calculations for the tree architecture 24 may be performed in one FPGA 12, while other node calculations may be performed in a different FPGA 12, and some of the larger node calculations may be divided among one or more FPGAs 12. Generally, however, calculations for nodes 26 that have connectivity and are clustered together on the tree architecture 24 are performed in the same FPGA 12. An exemplary distribution of the tree architecture 24 for a 32-point FFT is shown in FIG. 4. The example illustrates how those nodes 26 that are connected within the tree architecture 24 are distributed on the same FPGA 12. FIG. 4 also illustrates that the largest node, which is the root node 32, for N=32, may be split among the already-utilized FPGAs 12, or the root node 32 may be distributed among one or more other FPGAs 12.

FIG. 5. shows an example of the flow of calculations for a 32-point FFT that is derived from the tree architecture 24 of FIGS. 3 and 4, and that is implemented using the initial calculation modules 16 and the butterfly modules 22. Depicted in FIG. 5 are a plurality of initial calculations modules 16 and butterfly modules 22 to perform the calculations for each node 26. There are a plurality of numbered boxes in a column at the left side of FIG. 5 that represent the data input set presented in bit-reverse order from the top of the figure to the bottom of the figure. There are also a plurality of numbered boxes that represent the inputs to and the outputs from each node 26 of calculations. The calculations for the nodes 26 of medium to large size (N>4) are generally performed by a plurality of N=4 butterfly modules 22, such that the number of N=4 butterfly modules 22 that are required for a given node size is determined by N/4. For example, the number of N=4 butterfly modules 22 required for the N=32 node is 32/4, or eight butterfly modules 22 for the N=32 node.

The calculations performed at the leaf nodes 28 are generally performed by the initial calculations module 16. The calculations for a leaf node 28 of N=2 may be performed by the initial calculations module 16 configured with two N=2 processors 38. Generally, the leaf nodes 28 of N=2 occur in pairs, such that one N=2 processor 38 can handle the first N=2 calculation, while the other N=2 processor 38 handles the second N=2 calculation. The calculations for a leaf node 28 of N=4 may be performed by a single N=4 processor 40, as opposed to decomposing the N=4 calculation to include an N=2 node 26. Thus, as depicted in the implementation of FIG. 5, there is one level of leaf node 28 calculations, with N=4 calculations being performed by an N=4 configured initial calculations module 16 and N=2 calculations being performed by an initial calculations module 16 configured for two N=2 calculations in parallel.

The implementation of the system 10 as shown in FIG. 5, with a plurality of initial calculations modules 16 and a plurality of butterfly modules 22, may also represent the resources that are utilized within the FPGAs. Actual realization of the system 10 within the plurality of FPGAs may depend on various constraints. For example, maximum system throughput of data may be desired, while in other circumstances, minimum usage of resources or minimum system power consumption may be desired. In various embodiments, each initial calculations module 16 and butterfly module 22 may be mapped to a unique, dedicated initial calculations module 16 and a unique, dedicated butterfly module 22, respectively, that are implemented in one or more FPGAs 12. This one-to-one mapping may achieve maximum throughput of data. In other embodiments, a single initial calculations module 16 or a single butterfly module 22 may be used to perform multiple calculations in a reusable fashion for the same FFT computation. In these embodiments, the system 10 may be mapped onto fewer FPGAs 12 and thereby may achieve lower power consumption and a lower implementation cost.

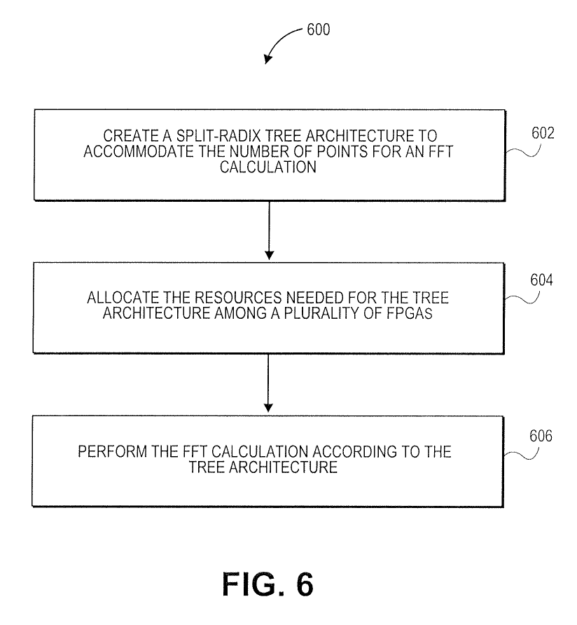

At least some of the steps that are performed in a method for calculating an FFT in accordance with various embodiments of the current invention are shown in the flow diagram 600 of FIG. 6. The steps as shown in FIG. 6 do not imply a particular order of execution. Some steps may be performed concurrently instead of sequentially, as shown. Additionally, some steps may be performed in reverse order from what is shown in FIG. 6. The steps may include creating a split-radix tree architecture 24 to accommodate the number of points for an FFT calculation, referenced at step 602 in FIG. 6; allocating the resources needed for the tree architecture 24 among a plurality of FPGAs 12, referenced at step 604; and performing the FFT calculation according to the tree architecture 24, referenced at step 606.

In connection with step 602 of FIG. 6, the split-radix tree architecture 24 is created. The tree architecture 24 may be created using the recursive split-radix algorithm, discussed above. The algorithm creates the shape of the tree architecture 24, but not the size of the tree. The size of the tree architecture 24 is determined by the number of sampled data points, N, that are the input data set. Generally, the point-size, N, is set to remain constant for a plurality of consecutive calculations. Accordingly, the tree architecture 24 remains constant for a plurality of consecutive calculations as well.

In connection with step 604 of FIG. 6, the resources that are needed to implement the system 10 according to the tree architecture 24 are allocated among a plurality of FPGAs 12. The specific implementation may depend on a number of factors, including the resources that are available. Each FPGA 12 has a finite number of CLBs and other resources. As a result, larger point-size FFTs may require more FPGAs 12. The implementation may also depend on performance requirements. A requirement for higher data throughput may require that every node 26 of the tree have one or more dedicated initial calculations modules 16 or butterfly modules 22, leading to more resources, and possibly more FPGAs 12, being utilized. Alternatively, there may be a requirement for lower power consumption or lower implementation cost, leading to reusage of initial calculations modules 16 and/or butterfly modules 22 to perform multiple calculations per node 26 or calculations for multiple nodes 26 within the same FFT. Hence, there may be fewer FPGAs 12 utilized in the system 10.

Step 604 may also include the substeps of creating the FPGA 12 structure and programming the FPGAs 12. The FPGA 12 structure may be created by generating one or more code segments in an HDL that describe the behavior or the architecture of the system 10, which is then synthesized and/or compiled into FPGA-ready code. The FPGA 12 structure may also be created by inputting one or more schematics that display the circuitry or components necessary to perform the calculations into a schematic-capture or similar EDA tool that produces FPGA-ready code. The FPGA 12 may be programmed with the FPGA-ready code by using standard FPGA-programming equipment.

In connection with step 606 of FIG. 6, the FFT calculation is performed according to the tree architecture 24. Data enters the system 10 through the external device 36 and communications bus 34 and is received by the external interface 14. The data may be buffered placed in bit-reversed order in preparation for the computation by the external interface 14, the initial calculations module 16, or a combination of both. The calculation begins with the leaf node 28 calculations, seen as the lowest nodes 26 in the tree architecture 24 of FIG. 3 for a 32-point FFT, which are performed by the initial calculations module 16, which may also be seen on the left side of FIG. 5. The results from the initial calculations modules 16 are sent to the appropriate butterfly modules 22 in order to perform the calculations at the branch nodes 30. Data continues to flow from branch node 30 to branch node 30 through the tree architecture 24 until the final calculations are performed at the root node 32. The output of the root node 32 calculations is frequency domain results of the FFT computation, which are then sent out of the system 10 through the external interface 14 on one or more FPGAs, the communications bus 34, and the external device 36. Due to the sequential nature of the calculation, in various embodiments, the system 10 may operate in a pipeline fashion, such that the leaf node 28 calculations are performed for a new data set while the larger node calculations are being performed for the current set of data.

The invention is disclosed primarily to be utilized in computing the fast Fourier transform. However, the system may be used to perform other calculations that are implemented using a tree-based architecture and include distributed processing elements, such as the inverse fast Fourier transform, which generally transforms frequency-domain data points into a time-domain data set.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A fast Fourier transform computation system, the system comprising:
a plurality of field programmable gate arrays including a plurality of configurable logic elements that are configured to perform mathematical calculations;
a plurality of initial calculations modules that are formed from the configurable logic elements and are implemented according to a split-radix tree architecture with a plurality of interconnected nodes to perform a plurality of initial split-radix calculations of the fast Fourier transform;
and
a plurality of butterfly modules that are formed from the configurable logic elements and are implemented according to the split-radix tree architecture to perform at least a portion of the calculations of the fast Fourier transform in an order determined by the connection of the nodes of the split-radix tree architecture.

2. The system of claim 1, further including a plurality of field programmable gate array interfaces each included within one field programmable gate array to allow the butterfly modules implemented in one field programmable gate array to communicate with the butterfly modules implemented in another field programmable gate array.

3. The system of claim 1, further including a plurality of external interfaces each included within one field programmable gate array to receive time-domain sampled data from an external source and to transmit frequency domain data corresponding to the results of the fast Fourier transform computation to the external source.

4. The system of claim 1, further including a real-data compensation module to properly order the computation results when only real data is used in the fast Fourier transform computation.

5. The system of claim 1, wherein the tree architecture includes a plurality of leaf nodes associated with the calculations performed by the initial calculations modules, and a plurality of branch nodes and a single root node associated with the calculations performed by the butterfly modules.

6. The system of claim 5, wherein the calculations of the leaf nodes are performed before the calculations of the branch nodes, which are performed before the calculations of the root node.

7. The system of claim 1, wherein the size of the tree architecture is related to a number of points for the fast Fourier transform computation.

8. A fast Fourier transform computation system, the system comprising:
a plurality of field programmable gate arrays including a plurality of configurable logic elements that are configured to perform mathematical calculations;
a plurality of initial calculations modules that are formed from the configurable logic elements and are implemented according to a split-radix tree architecture with a plurality of interconnected nodes to perform the initial split-radix calculations of the fast Fourier transform;
a plurality of butterfly modules that are formed from the configurable logic elements and are implemented according to the split-radix tree architecture to perform at least a portion of the calculations of the fast Fourier transform in an order determined by the connection of the nodes of the split-radix tree architecture;
a plurality of field programmable gate array interfaces each included within one field programmable gate array to allow the butterfly modules implemented in one field programmable gate array to communicate with the butterfly modules implemented in another field programmable gate array; and
a plurality of external interfaces each included within one field programmable gate array to receive time-domain sampled data from an external source and to transmit frequency domain data corresponding to the results of the fast Fourier transform computation to the external source.

9. The system of claim 8, further including a real-data compensation module to properly order the computation results when only real data is used in the fast Fourier transform computation.

10. The system of claim 8, wherein the size of the tree architecture is related to a number of points for the fast Fourier transform computation.

11. The system of claim 8, wherein the tree architecture includes a plurality of leaf nodes associated with the calculations performed by the initial calculations modules, and a plurality of branch nodes and a single root node associated with the calculations performed by the butterfly modules.

12. The system of claim 11, wherein the calculations of the leaf nodes are performed before the calculations of the branch nodes, which are performed before the calculations of the root node.

13. A method of computing a fast Fourier transform, the method comprising the steps:
a) creating a split-radix tree architecture to accommodate a number of points for a fast Fourier transform computation;
b) creating within the tree architecture a plurality of interconnected nodes that include a plurality of leaf nodes, a plurality of branch nodes, and a single root node, wherein each node is associated with a plurality of mathematical calculations that compute at least a portion of the fast Fourier transform, and the connection of the nodes determines the order of the calculations;
c) allocating resources needed to compute the fast Fourier transform according to the tree architecture among a plurality of field programmable gate arrays; and
d) performing the fast Fourier transform computation according to the tree architecture wherein the calculations associated with the leaf nodes are performed before the calculations associated with the branch nodes which are performed before the calculations associated with the root node.

14. The method of claim 13, further including the step of allocating dedicated resources for each node of the tree architecture.

15. The method of claim 13, further including the step of allocating reusable resources for each node of the tree architecture.

16. The method of claim 13, wherein the resources are allocated by creating one or more segments of hardware description language code which are transformed to program the field programmable gate arrays.

17. The method of claim 13, wherein the resources include a plurality of initial calculations modules and a plurality of butterfly modules.
